(19) United States
(12) Patent Application Publication
(10) Pub. No.: US 2025/0025881 A1
(43) Pub. Date: Jan. 23, 2025

(54) SPACER FOR HOLDING PIPETTE TIP CARRIERS, WHICH ARE STACKED ONE OVER THE OTHER, SPACED APART

(71) Applicant: Eppendorf SE, Hamburg (DE)

(72) Inventor: Vito Brabetz, Ahrensburg (DE)

(73) Assignee: Eppendorf SE, Hamburg (DE)

(21) Appl. No.: 18/714,876

(22) PCT Filed: Nov. 18, 2022
(86) PCT No.: PCT/EP2022/082451

§ 371 Date: May 30, 2024

(30) Foreign Application Priority Data
Dec. 1, 2021 (EP) 21211549.7

(51) Int. Cl. B01L 9/00

(52) U.S. Cl. CPC B01L 9/543; B01L 2200/025; B01L 2300/123

(57) ABSTRACT

A spacer structured to support and space apart substantially rectangular panel-shaped pipette tip carriers from each other includes a frame defined by a substantially rectangular lateral wall including two longitudinal sides and two transverse sides. The frame includes a horizontal standing surface positioned on a lower edge of the frame and structured to rest on an upper face of a first pipette tip carrier. The frame further includes a horizontal support surface positioned on an upper edge of the frame and structured to support a lower face of a second pipette tip carrier and a plurality of pins protruding vertically upwards from the upper edge. A plurality of bending elements are positioned on the lateral wall and are structured to be bent in a direction running at an acute angle to adjacent longitudinal and transverse sides.

### CROSS REFERENCE TO RELATED INVENTION

This application is a national stage application pursuant to 35 U.S.C. § 371 of International Application No. PCT/EP2022/082451, filed on Nov. 18, 2022, which claims priority to, and benefit of, European Patent Application No. 21211549.7, filed Dec. 1, 2021, the entire contents of which are hereby incorporated by reference.

### TECHNOLOGICAL BACKGROUND

The following disclosure is directed to a spacer for holding substantially rectangular panel-shaped pipette tip carriers with holes and pipette tips inserted therein, which are stacked one over the other, spaced apart.

### BACKGROUND

Pipette tips are used in particular in biological, chemical, biochemical, medical or forensic laboratories in order to dose small quantities of liquid with the aid of pipetting devices. The pipetting devices are manual pipettes, automatic dosing stations, or laboratory machines (workstations). The pipetting devices have one or more channels in order to accommodate a single pipette tip or a plurality of pipette tips in a row or in a matrix arrangement. For this purpose, the pipetting devices have lugs or blind holes on or into which pipette tips can be clamped by their upper ends. The distances between the channels from each other are generally harmonized with the distances between the recesses in standardized microplates in accordance to the standard ANSI SBS 1 to 4; American National Standard; American National Standard Institute, 2006. To avoid contaminations between different samples, pipette tips consisting of plastic for single use are employed (disposables). These must be provided in large amounts for the performance of tests.

Panel-shaped and substantially rectangular pipette tip carriers with a plurality of holes in a matrix arrangement are used to provide pipette tips. The pipette tips are inserted into the holes from above, wherein they do not fall through due to an upwardly widening diameter or a collar. The pipette tip carrier is placed on the edge of an upper opening of a frame or box so that the pipette tips engage in the upper opening. When the frame or box is placed by the lower face on a horizontal surface, one or more pipette tips can be removed from the pipette tip carrier by pressing them onto the lugs or pressing them into the blind holes. After use, the pipette tips are discharged from the pipetting device into a container for disposal with the aid of a discharge device.

For the space-saving provision of a large number of pipette tips, it is known to stack pipette tip carriers on top of each other so that the pipette tips of a pipette tip carrier arranged above engage in the pipette tips of the pipette tip carrier arranged underneath. To prevent the pipette tips of the pipette tip carrier arranged above from jamming in the pipette tips of the pipette tip carrier arranged below and being pulled out of the pipette tip carrier arranged below while removing the pipette tip carrier arranged above from the stack, there must be a small free space between the interlocking pipette tips. For this purpose, it is known to provide the pipette tip carriers with a downwardly projecting, peripheral lateral wall which is supported outside the holes on a pipette tip carrier arranged below (see EP 2 784 076 A1). It is also known to arrange a frame-shaped spacer between pipette tip carriers which are stacked one over the other, the upper edge of which is supported outside the holes on the lower face of a pipette tip carrier arranged above, and the lower edge of which is supported outside the holes on the upper face of a pipette tip carrier arranged below. It is also known to connect the spacer to the upper pipette tip carrier by means of snap connections (see EP 2 839 880 A1).

EP 2 848 308 B1 describes a spacer which comprises centering spring elements arranged on the inside of the longitudinal sides and transverse sides of the lateral wall, each of which comprises a resilient part which is spaced apart from the inside of the lateral wall to which the centering spring element is attached. The resilient part can exert a spring effect between the inside of the respective lateral wall and a part of a pipette tip carrier to be stacked, which is received by a central opening in the spacer. The centering spring elements are designed in such a way that they act on a pipette tip carrier against which the spacer lies and minimize the horizontal play between the pipette tip carrier and the spacer without locking the pipette tip carrier to the spacer. This is intended to create an improved centering and stabilization of a carrier stack without locking all elements of the carrier stack to each other. This requires precise manufacturing of the spacers and the pipette tip carriers. In addition, due to the centering spring elements arranged on the inside of the longitudinal and transverse sides of the lateral wall, more material is used. In the exemplary embodiment, there are two centering spring elements on each longitudinal and transverse side, i.e. a total of eight.

### BRIEF SUMMARY OF THE INVENTION

Against this background, the object of the invention is to provide a spacer for stacked panel-shaped pipette tip carriers, which enables improved centering and stabilization of a carrier stack with reduced material usage and manufacturing effort.

An embodiment of the spacer according to the invention for holding panel-shaped and substantially rectangular pipette tip carriers which are stacked one over the other spaced apart comprises a peripheral lateral wall which forms a substantially rectangular frame with two longitudinal and two transverse sides in each case, said frame having a horizontal standing surface on a lower edge for supporting on the upper face of a pipette tip carrier, a horizontal support surface on an upper edge for supporting an additional pipette tip carrier on the lower face, pins protruding vertically upwards from the upper edge on corners between adjacent longitudinal and transverse sides, and bending elements on the lateral wall, wherein the bending elements can be bent in a direction running at an acute angle to the adjacent longitudinal and transverse sides.

In and embodiment of the spacer, centering of the spacer in the stack is achieved by the bending elements at the corners of the lateral wall, which can be bent in a direction running at an acute angle to the adjacent longitudinal and transverse sides. For this purpose, the bending elements can be bent or deflected by contours of an additional spacer and/or a pipette tip carrier supported on the support surface of the inserted additional spacer, which are inserted from below into the peripheral lateral wall, or lie against it without play. The bending element can be bent outwards or inwards relative to the frame of the spacer. A slight bend or deflection or play-free placement of the bending elements yields a centering of the spacer on the contours of the additional spacer inserted from below and/or a pipette tip carrier supported on the additional spacer. The forces acting due to the centering between the bending elements and the contours of the spacer or pipette tip carrier can be held low enough so that the spacer can be removed from the additional spacer and the pipette tip carrier supported thereon without the additional spacer or the pipette tip carrier being entrained. This can be achieved in particular by a particularly flexible design of the bending elements and/or by precise or low-tolerance production of the bending elements and the contours of the spacer and/or the pipette tip carrier. The spacer can be manufactured in a material-saving manner because the bending elements only have to be present at corners of the spacer, wherein formation on only two diametrically opposite corners is sufficient. Furthermore, the bending elements can be formed within the peripheral lateral wall, and no additional spring elements applied to the inside of the lateral wall are needed for this purpose. This can also reduce the cost of tools for injection molding the spacer and the overall cost of manufacturing the spacer. If the centering is performed by placing the bending elements on contours of another spacer of the same design, it may be sufficient to manufacture the spacer with the relevant contours and bending elements with correspondingly low tolerances and the pipette tip carrier with greater tolerances, which further reduces the manufacturing cost.

According to one embodiment of the invention, the bending elements can be bent by means of pins of an additional spacer of identical design inserted from below, and/or by means of corners or radii at the corners between adjacent longitudinal and transverse sides of a pipette tip carrier supported on the support surface of the additional spacer. The pins of the additional spacer and/or the corners or radii at the corners of the pipette tip carrier supporting the additional spacer form the contours by means of which the bending elements can be bent or deflected, or against which the bending elements rest without being bent or deflected. The pins of the additional spacer and/or corners or radii of a pipette tip carrier supported thereon are arranged at the corners of the spacer placed thereon so that they are particularly well suited for centering the spacer.

The pipette tip carrier which is used for centering the spacer, has a rectangular panel-shaped main body, holes extending vertically from the top to the bottom of the main body for receiving pipette tips, a circumferential edge around the main body with an upper contact surface arranged lower than the upper face of the main body for placing a spacer with a standing surface on the lower edge, and a lower contact surface on the downward-facing side for placing on a support surface on the upper edge of an additional spacer, and corners of the panel-shaped main body above the circumferential edge. Preferably, the corners of the panel-shaped main body have radii.

According to an additional embodiment, the pins are cylindrical and/or have a conical or spherical end. This makes it easier to place the spacer on another spacer while the bending elements contact with the pins.

According to an additional embodiment, the direction in which the bending elements can be bent is oriented diagonally to the corners of the frame. Accordingly, this direction extends along a straight line that connects two non-adjacent corners of the rectangular frame. The direction in which the bending elements can be bent can be aligned at different or the same acute angles relative to each of the neighboring longitudinal and transverse sides.

According to an additional embodiment, the spacer has the bending elements on at least two diametrically opposite corners, preferably on all four corners. Centering, which prevents a displacement in the direction of the longitudinal and transverse sides of the spacer, can already be achieved by bending elements that are only arranged at two diametrically opposing corners. Preferably, bending elements are arranged at all four corners in order to form particularly stable stacks.

According to an additional embodiment, the peripheral lateral wall is connected at the top to an inwardly projecting peripheral flange which has the standing surface on its upper face for supporting an additional pipette tip carrier. The peripheral flange increases the stability of the spacer. According to an additional embodiment, the pins protrude upwards from the top of the flange.

According to an additional embodiment, the bending elements have vertical cylindrical shells at the corners at a distance from the lateral wall, which are connected to the spacer at their upper ends. The cylindrical shells can be designed in such a way that they are supported on the radii of a pipette tip carrier which is supported on an additional spacer inserted with the pins into the peripheral lateral wall in order to bring about centering. In this case, the cylindrical shells rest against the radii of the pipette tip carrier with concave curved insides. In order to bend the cylindrical shells slightly in a radial direction toward the pins, they are only attached to the spacer at the upper ends. According to an additional embodiment, the cylindrical shells are integrally connected to the spacer.

According to an additional embodiment, the cylindrical shells each have one or more of the following features: (i) two vertical edges that are arranged symmetrically in relation to the corner at which the cylindrical shell is located, which allows a flat contact with the radii and good centering to be achieved; (ii) a lower edge that is arranged at the level of the standing surface of the spacer or above same, which allows the cylindrical shells to rest unhindered against the radii of the pipette tip carrier; (iii) an insertion stop on the lower edge on the inside of the cylindrical shell, which makes it easier to place the spacer on the pipette tip holder; and (iv) a connection of the circular arc-shaped upper edge to the lower face of the flange or at upper sections of the two vertical side edges with the lateral wall, which enables easy bending of the cylindrical shell due to a radius of the pipette tip carrier resting on the lower edge of the cylindrical shell.

According to an additional embodiment, the bending elements each have at least one vertical slot at one corner of the lateral wall, starting from the lower edge of the lateral wall and ending above the lower edge in the lateral wall. Bending elements are formed in the lateral wall by the slots. The slots make it easy to bend the adjacent regions of the lateral wall radially outwards by pins inserted from below. This embodiment is very material-saving since the bending elements are integrated into the lateral wall and the slots save material.

According to another embodiment, the vertical slots at the corners extend from the inside to the outside of the lateral wall. This results in very bendable bending elements. Alternatively, the vertical slots do not extend from the inside to the outside, whereby somewhat stiffer bending elements are formed. For example, the slots extend from the inside to just before the outside of the lateral wall, or from the outside to just before the inside of the lateral wall.

According to an additional embodiment, there are two vertical slots in the lateral wall at each corner. The regions of the lateral wall at the corners between two adjacent vertical slots are particularly flexible and can be placed against the inserted pins while further reducing the force.

According to an additional embodiment, the two vertical slots are arranged symmetrically in relation to the respective corner. This achieves uniform force guidance at the corners. According to another embodiment, only one vertical slot is arranged at each corner.

According to an additional embodiment, horizontal slots are arranged at the corners in the lateral wall, each of which extends from the corner into the two adjacent regions of the lateral wall, and the vertical slots each open at the top into the horizontal slot at the same corner. The horizontal slots further increase the bendability of the bending elements formed by the vertical slots and further reduce the forces between spacers which are stacked one over the other.

According to an additional embodiment, the lateral wall has an inner radius on the inside of each corner and/or an outer radius on the outside of each corner. The radius further increases the bendability of the bending elements. Furthermore, the radius on the inside of the lateral wall makes it easier to insert the pins of another spacer into the peripheral lateral wall of the spacer. For this purpose, according to an additional embodiment, the lateral wall has a radius at the corners on the inside that corresponds to or exceeds the radius of the pins. According to additional embodiments, the spacer comprises one or more of the following features:

The upper edge of the frame has a recess at each corner and the pin protrudes vertically upwards from the base surface of the recess. The recess can accommodate a radius or a cone at the lower end of the spigot so that it does not prevent the flat contact of a pipette tip carrier on the upper edge of the frame.

The pins become smaller towards the upper end. This makes it easier to insert the pins into the peripheral lateral wall and/or into holes at the corners of the pipette tip carrier. The pins have a conical base at the lower end.

The frame has downwardly projecting steps at the corners and/or in between, the lower edge of which forms at least part of the standing surface. This saves additional material.

The spacer consists of one or more plastics. These are, for example, polypropylene, polyethylene, polycarbonate, acrylonitrile-butadiene-styrene copolymers and/or polystyrene. In particular when manufactured from several plastics, the bending elements can be formed from a very bendable plastic. The spacer is manufactured from at least one plastic by injection molding.

Furthermore, an object of the invention is a transport unit for pipette tips comprising a pipette tip box, a pipette tip carrier placed on the pipette tip box and provided with pipette tips, and at least one arrangement placed on the pipette tip carrier comprising a spacer and an additional pipette tip carrier placed on the spacer and provided with pipette tips.

In an embodiment, the transport unit is formed in that one or more arrangements consisting of a spacer with a pipette tip carrier, which is provided with pipette tips, is placed on a pipette tip box and a pipette tip carrier, which is placed thereon and provided with pipette tip carriers. The pipette tips are held spaced apart in pipette tip carriers arranged one above the other by the at least one spacer so that they can engage in each other without jamming against each other. In this way, a space-saving or compact transport unit is achieved. The transport unit can also be used to store the pipette tips.

According to an additional embodiment, a cover is placed on a pipette tip carrier or on a spacer placed on a pipette tip carrier. The cover covers the transport unit at the top and protects it from contaminants. If the cover is placed on a pipette tip carrier, above which pipette tips inserted therein protrude slightly upwards, the cover can be hood-shaped or have recesses in the lower face to accommodate the protruding parts of the pipette tips. If the cover is placed on a spacer, it can be panel-shaped or hood-shaped.

Finally, an object of the invention is to use a spacer according to the invention to form a stack of pipette tip carriers spaced apart by means of spacers and provided with pipette tips.

### BRIEF DESCRIPTION OF THE DRAWINGS

The invention is explained in more detail below based on the accompanying drawings of exemplary embodiments.

FIG. 1 illustrates a perspective view from the front and side of a spacer with bending elements in the form of cylindrical shells.

FIG. 2 illustrates a top perspective view or an embodiment of stacked spacers with pipette tip carriers arranged therebetween.

FIG. 3 illustrates an enlarged diagonal sectional view of a portion of the embodiment of FIG. 2.

FIG. 4 illustrates an exploded top perspective view of an embodiment of spacers with pipette tip carriers and pipette tips.

FIG. 5 illustrates a corner perspective view of an embodiment of the spacer with bending elements formed by parallel vertical slots.

FIG. 6 illustrates a top perspective view of an embodiment of the spacers which are stacked one over the other with pipette tip carriers arranged therebetween.

FIG. 7 illustrates an enlarged sectional view of the embodiment of FIG. 6.

FIG. 8 illustrates a corner perspective view of an embodiment of a spacer with bending elements formed by a vertical slot.

FIG. 9 illustrates a top perspective view of an embodiment of stacked spacers with pipette tip carriers arranged therebetween.

FIG. 10 illustrates an enlarged sectional view of the embodiment of FIG. 9.

FIG. 11 illustrates a corner perspective view of another embodiment of a spacer with bending elements formed by a vertical and a horizontal slot.

FIG. 12 illustrates a top perspective view of another embodiment of stacked spacers with pipette tip holders arranged therebetween.

FIG. 13 illustrates an enlarged sectional view of the embodiment of FIG. 12.

### DETAILED DESCRIPTION OF THE INVENTION

In the present application, the terms “vertical” and “horizontal” as well as “top” and “bottom” and terms derived therefrom such as “above” and “below” refer to a spacer which is placed on a horizontal surface with its standing surface on the lower edge.

If different construction elements are designated with the same name, these are designated with the same reference number, a trailing dot and different individual reference numbers after the dot.

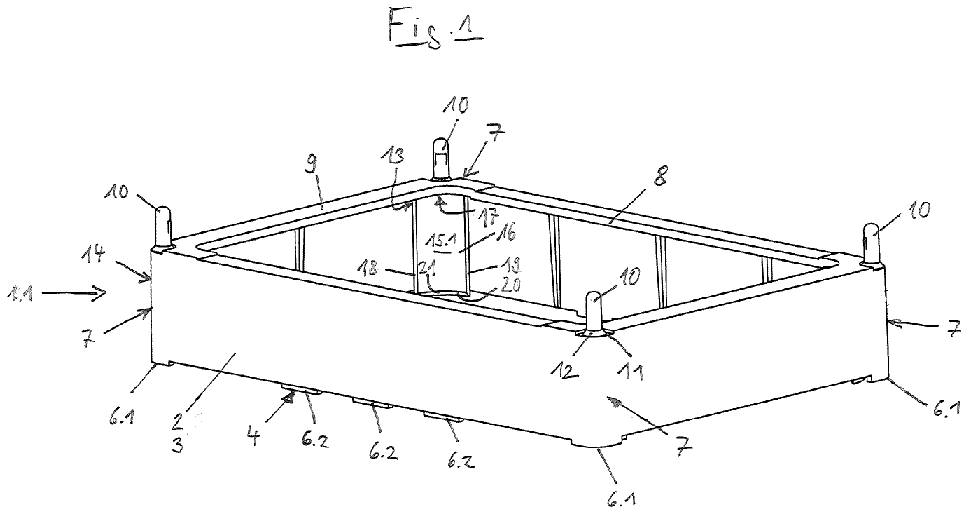

According to FIGS. 1 to 3, a spacer 1.1 has a peripheral lateral wall 2, which forms a substantially vertical frame 3 with two longitudinal and two transverse sides in each case. At the lower edge, the spacer has a horizontal standing surface 4 for resting on the upper face of a pipette tip carrier 5. The horizontal standing surface 4 comprises a step 6.1 at each corner 7 and three steps 6.2 on each longitudinal side of the frame.

At the upper edge, the spacer 1.1 has an inwardly projecting peripheral flange 8. The upper face of the flange 8 is a horizontal support surface 9 for supporting another pipette tip carrier 5 on the lower face.

At each corner 7, a pin 10 projects upwards from the peripheral flange 8. Each pin 10 is arranged in a recess 11 in the upper face of the flange 8 and has a conical base 12 at the lower end, which is arranged inside the recess 11. Furthermore, each pin 10 tapers towards the upper end. At the corners 7, the lateral wall 2 has an inner radius 13 on the inside and an outer radius 14 on the outside.

At the corners 7, the spacer 1.1 has bending elements 15.1 in the form of cylindrical shells 16 which are arranged at a distance from the lateral wall 2 inside the frame 3 and are integrally connected to the flange 8 at their arc-shaped upper edge 17. The cylindrical shells 16 have two vertical lateral edges 18, 19. Their circular arc-shaped lower edge 20 is arranged at the same level as the standing surface 4 of the spacer 1.1 or is offset slightly upwards relative thereto. Furthermore, the cylindrical shells 16 have an inlet slope 21 at the lower edge on the inside.

The spacer 1.1 is preferably made in one piece from plastic. The spacer 1.1 preferably is comprised of one or more plastics. Preferably, the spacer 1.1 is formed from an injection molding process. In an embodiment, plastics polypropylene (PP), polyethylene E), polycarbonate (PC), acrylonitrile-butadiene-styrene copolymers (ABS) or polystyrene (PS) may be used to form the spacer 1.1. In an embodiment, the spacer 1.1 is at least partially comprised of an economical plastic such as polypropylene.

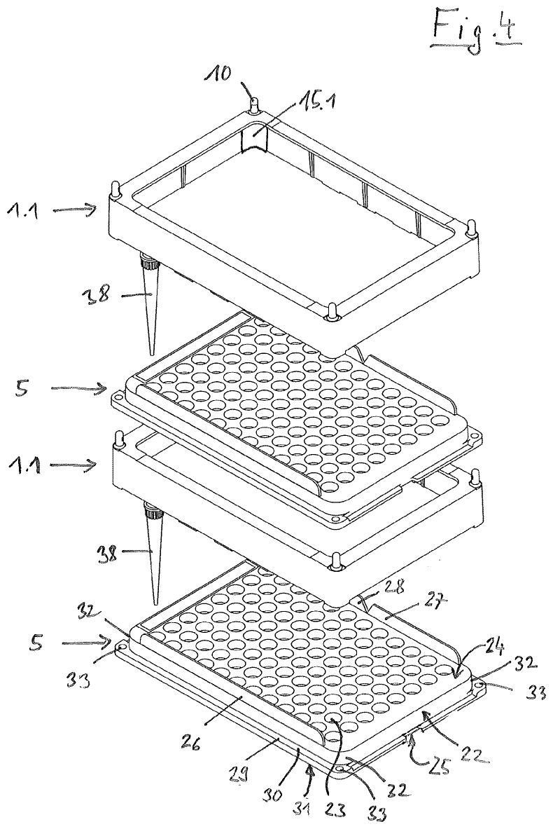

According to FIG. 4, a pipette tip carrier 5 has a substantially panel-shaped main body 22 with a plurality of holes 23 that extend from the upper face 24 to the lower face 25 of the main body 22. The holes 23 are arranged regularly in rows and columns of a matrix. In the example, there are 96. The pipette tip carrier 5 has two long edges and two short edges. At a small distance from the long edges, it has panel-shaped gripping edges 26, 27, 28 that are parallel to said long edges and protrude from the top 24.

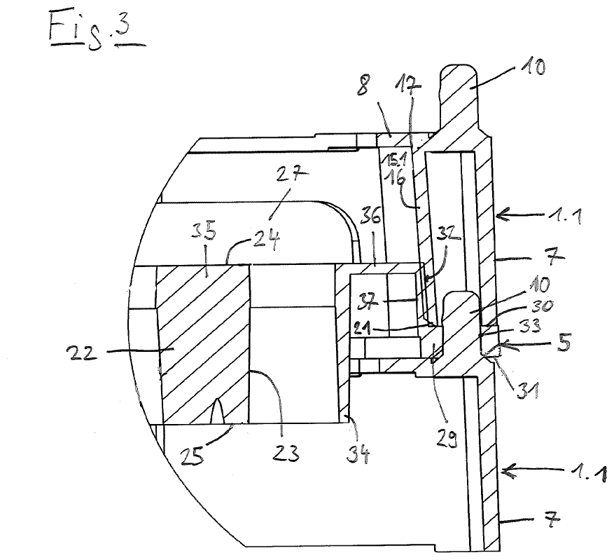

The pipette tip carrier 5 has an edge 29 running around the main body 22 with a flat upper contact surface 30 and a flat lower contact surface 31. The upper contact surface 30 is arranged slightly below the upper face 24 of the main body 22, and the lower contact surface 31 is arranged slightly above the lower face 25 of the main body 22 (see FIG. 3). At the corners of the pipette tip carrier 5, the panel-shaped main body 22 has radii 32 above the peripheral edge 29, and the peripheral edge 29 has through-holes 33.

The radii 32 and the cylindrical shells 16 are designed so that the cylindrical shells 16 are deflected slightly outwards from the radii 32 or rest against each other without play from partially inserting a pipette tip carrier 5 from below into the peripheral lateral wall 2. In so doing, the pipette tip carrier 5 is placed or clamped onto the upper face of the lower spacer 1.1. Each bore 33 has a conical section at the bottom and a cylindrical section adjacent thereto. The dimensions of the holes 33 are selected so that the pins 10 of the spacer 1.1 can be pressed into them. The conical sections form insertion bevels that facilitate the insertion of the pins 10 into the holes 33. Moreover, tapers at the upper ends of the pins 10 facilitate insertion into the holes 33.

In the example, the main body 22 is configured like a quiver plate. In this case, the holes 23 are formed in quiver or sleeve-shaped structures 34 which are connected to each other laterally by webs 35 and at the upper edge by a plate 36. A skirt 37 runs around the outside of the plate 36, and the peripheral edge 29 projects outwards from the lower edge of the skirt 37 (see FIG. 3). Instead, the pipette tip carrier 5 can also be configured as a web plate, wherein a thin plate with a plurality of holes in the lower face has webs encompassing the holes. Instead, the pipette tip carrier 5 can also be designed solid, i.e. without cavities outside the holes 23 and bores 31.

Pipette tips 38 can be inserted into the holes 23 from above and are supported by a collar 39 on the edge of the holes. The pipette tip carrier 5 is preferably manufactured in one piece. It is also preferably manufactured from plastic. In an embodiment, the tip carrier 5 is formed by an injection molding process. In particular, the plastics polypropylene (PP), polycarbonate (PC), acrylonitrile-butadiene-styrene copolymers (ABS), polystyrene (PS) can be used for this purpose.

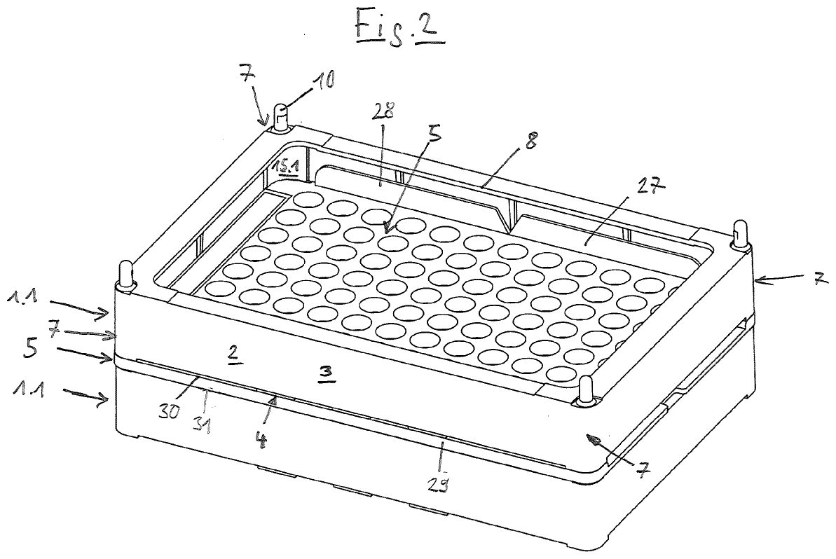

According to FIGS. 2 and 3, the pipette tip carrier 5 is pressed by the bores 33 onto the pins 10 of the lower spacer 1.1 so that the upper section of the pins 10 of the lower spacer 1.1 projects upwards with respect to the main body 22 of the pipette tip carrier 5. Alternatively, the pins 10 can also be inserted into the bores 33 with play. The upper spacer 1.1 rests with its standing surface 4 outside the gripping edges 26, 27, 28 on the upper contact surface 30 of the pipette tip carrier 5, and the lower spacer 1.1 rests with its support surface 9 on the lower contact surface 31 of the pipette tip carrier 5. The projecting sections of the pins 10 are inserted into the peripheral lateral wall 2 of the upper spacer 1.1, and the cylindrical shells 16 or bending springs 15.1 of the upper spacer 1.1 lie against the radii 32 of the pipette tip carrier 5 that the lower spacer 1.1 bears. By slightly bending out the bending springs 15.1, precise centering of the spacer 1.1 on the pipette tip carrier 5 and stable stack formation are achieved. For stable stack formation, the pins 10 have a press fit in the bores 33 or are guided therein free of play.

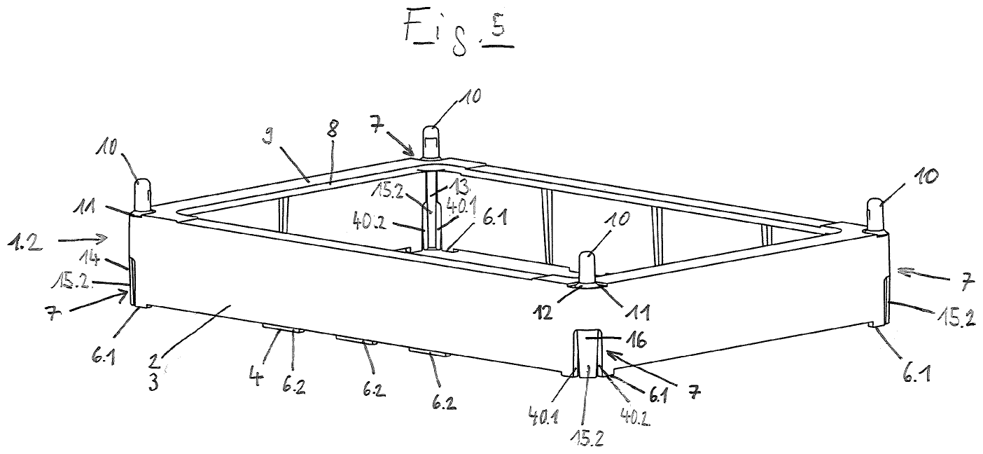

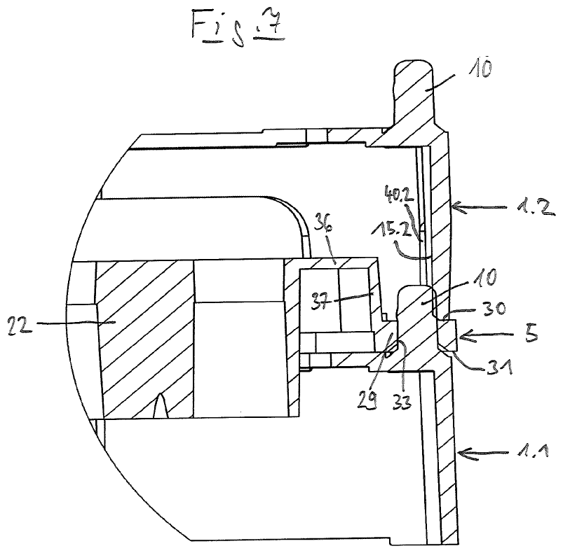

The spacer 1.2 of FIGS. 5 to 7 differs from the one described above in that, instead of a cylindrical shell 16, there are two vertical slots 40.1, 40.2 at each corner 7, which proceed from the lower edge of the lateral wall 2 and end below the upper edge of the lateral wall 2. In the example, they end approximately up to half the height of the lateral wall 2. The two vertical slots 40.1, 40.2 are formed symmetrically relative to the respective corner 7. The vertical slots 40.1, 40.2 each extend from the inside to the outside of the lateral wall 2. At each corner 7, the region between the two vertical slots forms a bending element 15.2 in the form of a bending spring.

The inner radius 13 at the corners 7 of the lateral wall 2 corresponds with the radius of the pin 9 or slightly exceeds it. The pins 10 and the corners 7 of the spacer 1.2 are configured so that the pins 10 of another identical spacer 1.2 or 1.1 can be inserted from below into the peripheral lateral wall 2 and rest against the inner radii 13 of the corners 7, while slightly bending out the bending elements 15.2. This achieves precise centering of the spacers 1.2 or 1.2 and 1.1 against each other and stable stacking.

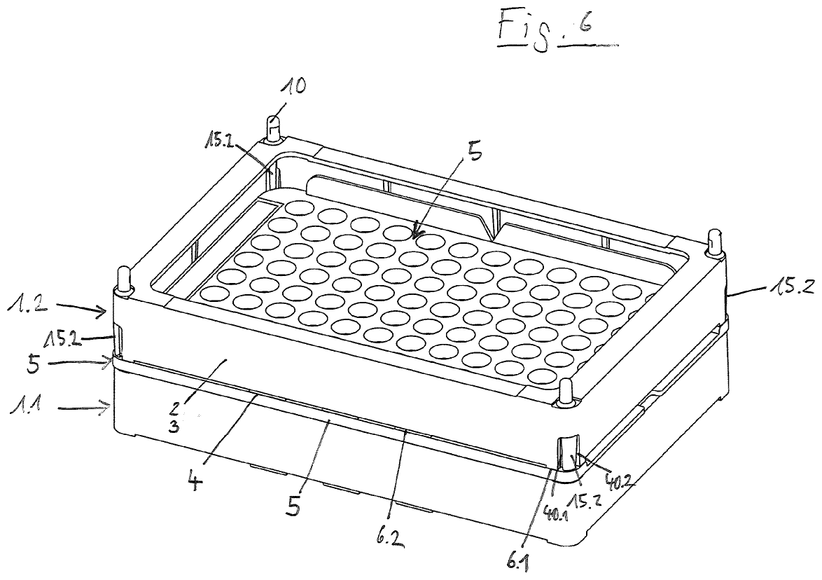

According to FIG. 6, the spacer 1.2 is placed with its standing surface 4 on a pipette tip carrier 5. The pipette tip carrier 5 is preferably placed on the support surface 9 of another spacer 1.2 of identical construction. According to FIG. 6, the pipette tip carrier 5 is placed on the standing surface 9 of a spacer 1.1 since the various exemplary embodiments can also be combined with each other.

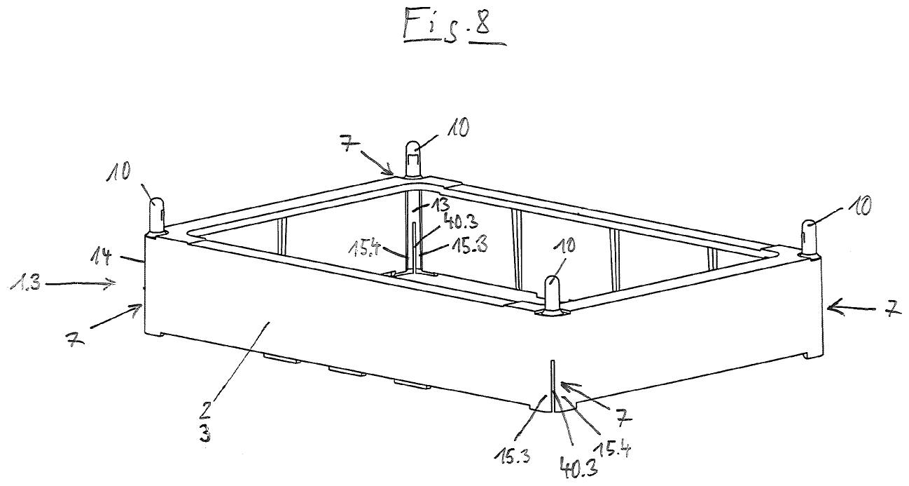

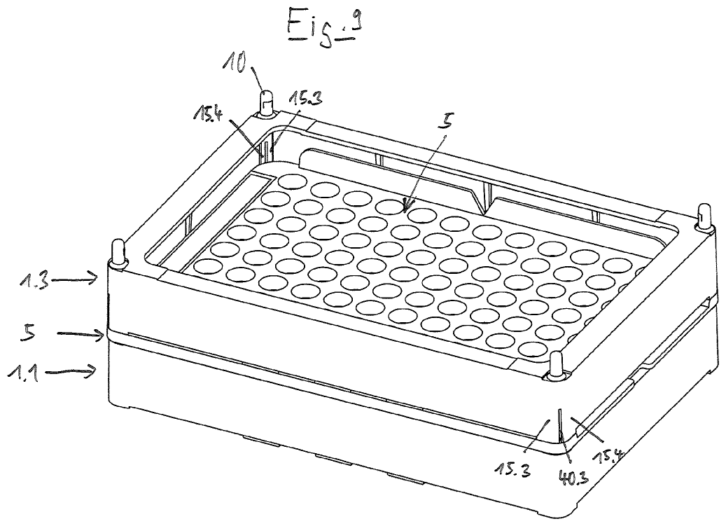

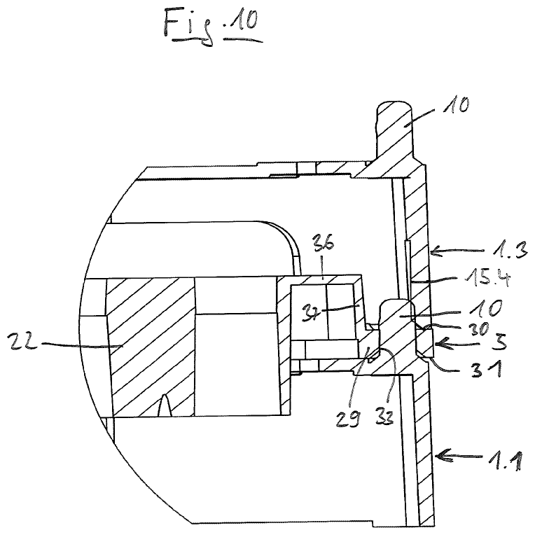

The spacer 1.3 of FIGS. 8 to 10 differs from the one described above in that it has only a single vertical slot 40.3 at each of the corners 7, which proceeds from the lower edge of the lateral wall 2 and ends at a distance from the upper edge of the lateral wall 2, approximately at half the height of the lateral wall 2. The vertical slots 40.3 are each arranged in the middle of the corner 7. At each corner 7, the regions adjacent to the slot 40.3 form bending elements 15.3, 15.4 which can be bent slightly outwards by pins 10 of an additional spacer 1.3, 1.2 or 1.1 inserted from below.

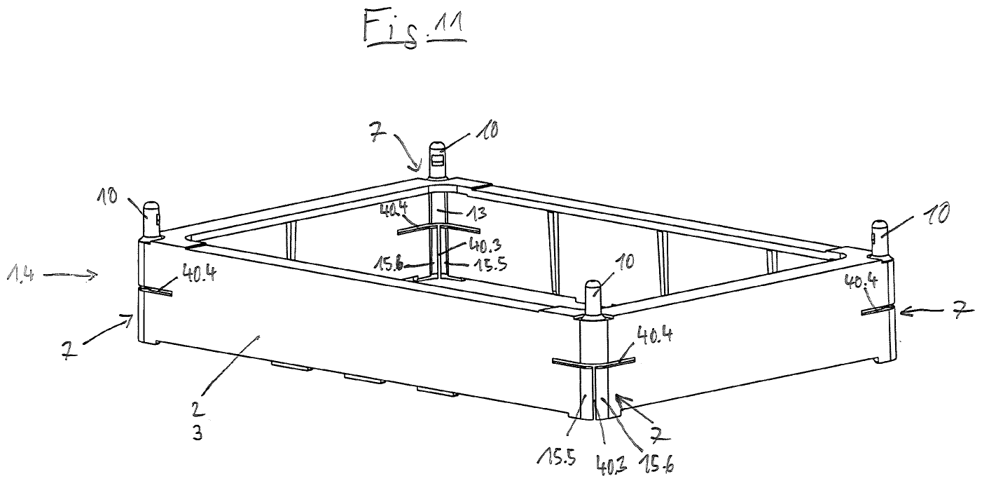

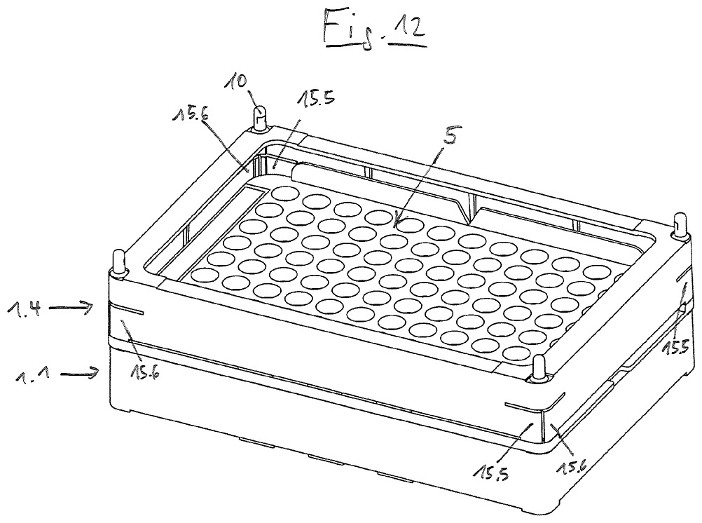

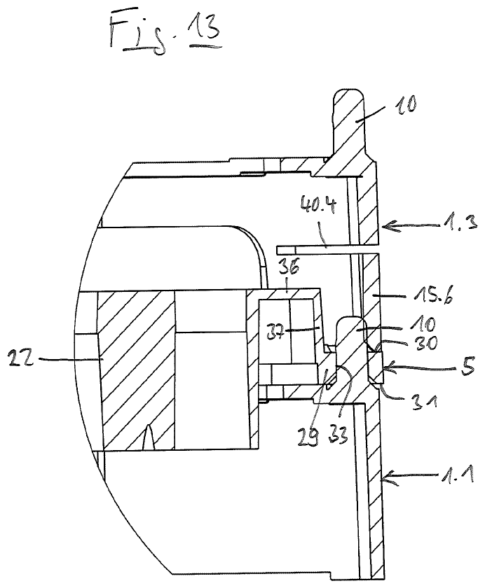

The spacer 1.4 of FIGS. 11 to 13 differs from the one described above in that a horizontal slot 40.4 is at each corner 7 in addition to the vertical slot 40.3. The horizontal slot 40.4 extends from the upper end of the vertical slot 40.3 on both sides a bit into the adjacent transverse sides and longitudinal sides of the spacer 1.4. The horizontal slot 40.4 increases the bendability of the bending elements 15.5, 15.6 adjacent to the vertical slot.

### LIST OF REFERENCE SIGNS

1.1 bis 1.4 Spacers
2 Side wall
3 Frame
4 Standing surface
5 Pipette tip carrier
6.1, 6.2 Step
7 Corner
8 Flange
9 Support surface
10 Pin
11 Recess
12 Base
13 Inner radius
14 Outer radius
15.1 to 15.6 Bending element
16 Cylindrical shell
17 Circular arc shaped upper edge
18, 19 Vertical edge
20 Circular arc shaped lower edge
21 Insertion stop
22 Main body
23 Hole
24 Upper facc
25 Lower face
26, 27,28 Gripping edge
29 Peripheral edge
30 Upper contact surface
31 Lower contact surface
32 Radius
33 Bore
34 Sleeve-shaped structure
35 Web
36 Plate
37 Skirt
38 Pipette tip
39 Collar
40.1 to 40.4 Slot

1-18. (canceled)

19. A spacer configured to hold and space apart substantially rectangular panel-shaped pipette tip carriers which are stacked one over another, comprising:
a frame defined by a substantially rectangular lateral wall comprising two longitudinal sides and two transverse sides, wherein the frame comprises,
a horizontal standing surface positioned on a lower edge of the frame and configured to rest on an upper face of a first pipette tip carrier,
a horizontal support surface positioned on an upper edge of the frame and configured to support a lower face of a second pipette tip carrier,
a plurality of pins protruding vertically upwards from the upper edge, and
a plurality of bending elements positioned on the lateral wall and configured to be bent in a direction running at an acute angle to adjacent longitudinal and transverse sides.

20. The spacer according to claim 19, wherein the plurality of bending elements are configured to be bent by pins of an additional spacer of identical configuration and inserted from below.

21. The spacer according to claim 19, wherein the plurality of bending elements are configured to be bent by radii at the corners between adjacent longitudinal and transverse sides of the pipette tip carrier supported on a support surface of an additional spacer of identical configuration and inserted from below.

22. The spacer according to claim 19, wherein the plurality of bending elements are positioned at at least two diametrically opposite corners of the frame.

23. The spacer according to claim 21, wherein the lateral wall is connected to an inwardly projecting peripheral flange comprising an upper face, and wherein the support surface is defined on the upper face.

24. The spacer according to claim 19, wherein the plurality of bending elements each comprise vertical cylindrical shells connected to the frame.

25. The spacer according to claim 24, wherein the cylindrical shells each comprise at least one of:
(i) two vertical edges arranged symmetrically relative to a corner of the frame;
(ii) a circular arc-shaped lower edge arranged at or above a level of a standing surface;
(iii) an insertion stop positioned on an inside of the circular arc-shaped lower edge;
(iv) a connection positioned at the upper end and configured to connect to the lower face of a flange; and
(v) a connection to the frame positioned at upper sections of two vertical side edges.

26. The spacer according to claim 19, the plurality of bending elements are positioned at corners of the frame and each comprise each comprise at least one vertical slot proceeding from the lower edge of the lateral wall and below the upper edge in the lateral wall.

27. The spacer according to claim 26, wherein the at least one vertical slot extends from an inside to an outside of the lateral wall.

28. The spacer according to claim 26, further comprising two vertical slots at each corner.

29. The spacer according to claim 28, wherein the two vertical slots are each arranged symmetrically relative to each corner.

30. The spacer according to claim 27, wherein only one vertical slot is arranged at each corner.

31. The spacer according to claim 29, further comprising one or more horizontal slots positioned at each corner of the lateral wall, wherein each of the one or more horizontal slots extends from the corner into two adjacent regions of the lateral wall, and the two vertical slots each open at a top into the horizontal slot at the same corner.

32. The spacer according to claim 19, wherein the lateral wall further comprises at least one of:
(i) an inner radius on an inner side at each corner; and (ii) an outer radius on an outer side at each corner.

33. The spacer according to claim 19, wherein the lateral wall comprises an inner radius on an inner side of each corner that is at least equal to a radius of the plurality of pins.

34. The spacer according to claim 19, comprising at least one of:
(i) a recess defined in the upper edge of the frame at each corner;
(ii) each of the plurality of pins projects vertically upwards from a base surface of the recess;
(iii) each of the plurality of pins tapers towards an upper end;
(iv) each of the pins comprises a conical base at a lower end;
(v) downwardly projecting steps positioned on the lower edge of the frame which forms at least part of the standing surface;
(vi) wherein the spacer comprises one or more plastics;
(vii) wherein the spacer comprises at least one of polypropylene, polyethylene, polycarbonate, acrylonitrile-butadiene-styrene copolymer, and polystyrene; and
(viii) wherein the spacer is manufactured from one or more plastics using an injection molding process.

35. A transport unit for pipette tips comprising:
a pipette tip box;
a pipette tip carrier placed on the pipette tip box and provided with pipette tips; and
at least a spacer according to claim 19; and
an additional pipette tip carrier placed on the spacer and provided with pipette tips.

36. The transport unit according to claim 35, further comprising a cover configured to be placed on the pipette tip carrier or on the spacer.

37. A transport unit for pipette tips comprising a stack of three or more pipette tip carriers provided with pipette tips and each spaced apart from each other by a spacer according to claim 19.
